(19) United States
(12) Patent Application Publication
(10) Pub. No.: US 2024/0296110 A1
(43) Pub. Date: Sep. 5, 2024

(54) Apparatuses, Devices, Methods and Computer Program for Performing Unit Tests on Firmware Code

(71) Applicant: Intel Corporation, Santa Clara, CA (US)

(72) Inventors: Tao ZHAO, Shanghai (CN); Yun LIU, Shanghai (CN); Edwin Lei WANG, Shanghai (CN)

(21) Appl. No.: 18/572,201

(22) PCT Filed: Sep. 29, 2021
(86) PCT No.: PCT/CN2021/121797

§ 371 Date: Dec. 20, 2023

(51) Int. Cl. G06F 11/36

(52) U.S. Cl. CPC G06F 11/3688; G06F 11/3664

(57) ABSTRACT

Examples relate to an apparatus, device, method, and computer program for performing unit tests on firmware code, and to an apparatus, device, method, and computer program for preparing data for performing unit tests on firmware code. The firmware code is suitable for interacting with a hardware device. The apparatus comprises circuitry configured to obtain a timeline of changes of transaction data encountered at one or more interfaces of the hardware device during simulation of the hardware device, the simulation being based on one or more simulation parameters defined by one or more unit tests to be performed on the firmware code. The circuitry is configured to perform the one or more unit tests of the firmware code using the timeline of changes of transaction data of the simulated hardware device, the one or more unit tests being based on the one or more simulation parameters.

### FIELD

Examples relate to an apparatus, device, method, and computer program for performing unit tests on firmware code, and to an apparatus, device, method, and computer program for preparing data for performing unit tests on firmware code.

### BACKGROUND

The Pre-Silicon Stage (PSS) is an important period in the silicon product development lifecycle. The silicon features and the supporting firmware is usually verified during this phase, which precedes Tape-in and Power-on, so that the project can move forward smoothly with a solid foundation. In industry practice, simulation is widely used for firmware validation before the silicon or hardware platform is available.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for performing unit tests on firmware code;

FIGS. 1b and 1c show flow charts of examples of a method for performing unit tests on firmware code;

FIG. 2a shows a block diagram of an example of an apparatus or device for preparing data for performing unit tests on firmware code;

FIG. 2b shows a block diagram of an example of a system comprising an apparatus or device for preparing data for performing unit tests on firmware code and an apparatus or device for performing unit tests on firmware code;

FIG. 2c shows a flow chart of an example of a method for preparing data suitable for performing unit tests on firmware code;

FIG. 3a shows a schematic diagram of a memory reference code subsystem;

FIG. 3b shows a schematic diagram of a memory reference code subsystem with a black-box simulation;

FIG. 3c shows a schematic diagram of a memory reference code subsystem with a white-box simulation;

FIG. 4 shows a schematic diagram outlining a flow of data in a deployment for memory reference code validation; and

FIGS. 5a and 5b show a schematic representation of training data and result of captured transaction data.

### DETAILED DESCRIPTION

Some examples are now described in more detail with reference to the enclosed figures. However, other possible examples are not limited to the features of these examples described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/example,” “some embodiments/example,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/example,” “in some embodiments/examples,” and/or “in various embodiments/examples,” each of which may refer to one or more of the same or different embodiments or examples. Furthermore, the terms “comprising,” “including,” “having,” and the like, as used with respect to embodiments of the present disclosure, are synonymous.

Various examples of the present disclosure relate to a hybrid pre-silicon validation methodology that is based on using software simulations.

In many pre-silicon validation workflows, two kinds of simulations are used.

A first simulation is used to simulate the register interface/behavior. In the first simulation, the silicon IP (intellectual property) block is treated as a black box, which exports (all) the registers for upper layer software to access. In hardware design, an IP block is a block of (logic) circuitry that can be included, in a software-based hardware design tool, as a uniform (black-box) component. This is mainly used for firmware (developers to execute the basic code logic and unblock the feature development. For example, in MRC (Memory Reference Code in UEFI, Unified Extensible Firmware Interface) firmware validation, the software simulation tools like Simics and RcSim are used to execute the memory initialize and training flows in various configurations. This approach is easy to implement and can run very fast, however, due to lack of silicon/hardware logic simulation, the transaction data is always provided statically in order to keep the flow running, the data is usually ideal and cannot cover the various scenarios as in the real world.

A second simulation is used to simulate the silicon logic using an HDL (Hardware Description Language) representation of the hardware or using a representation of the hardware that is programmed into an FPGA (Field-Programmable Gate Array). This approach does not only implement all the registers, but also the internal silicon logic, thus it is much close to the actual data flow and can simulate different usage scenarios with end to end coverage. A firmware validation team can leverage this method, however, due to its focusing on silicon validation for HDL correctness, the test cases and flows are quite different from what firmware validation used on hardware platform. Compared with the first simulation, the execution speed is very slow, and the cost is so expensive that it is not suitable for a firmware developer and a validation team to use as regression or unit test vehicle.

In firmware validation in the pre-silicon phase, usually either the first simulation or the second simulation is used, with each of them having advantages and disadvantages. Such approaches might not achieve both coverage and efficiency at the same time.

With only the register interface implemented, the first simulation may have the coverage limitation from the validation perspective. In the case of the MRC test, memory training depends on the external electronic signals so that the BIOS (Basic Input/Output System) code (implementing training algorithm) can adjust the signal delay and voltage level according to the feedback from DIMM (Dual Inline Memory Module). However, since there is no external feedback in this simulation environment, the respective methods are hard coded with known-good responses so that the code can be executed smoothly. With this simulation, only the correct path may be verified, but it may be difficult to cover the different conditions.

On the other hand, the second simulation with HW logic implemented, such as CTE (Cluster Test Environment) environment for memory pre-silicon validation, can have the clock, control, and data signals in transaction just like the real HW platform, albeit at low execution speed and high execution costs. The CTE environment with the Memory Controller (MC) and DDRIO PHY (Double Data Rate Input Output Physical layer) simulation may take several days to finish one configuration with the basic training steps, which cannot meet the cadence requirement for firmware validation.

As shown above, each simulation method has its advantages and disadvantages. The proposed concept may address the dilemma of how to test the firmware in the pre-silicon phase in a fast and efficient way, and with a comprehensive test scenario coverage.

Various examples of the present disclosure are based on the finding, that the advantages of the first and second simulation can be leveraged to create a hybrid validation model. For example, with respect to the afore-mentioned MRC validation case, the memory training transaction data may be recorded from the second simulation execution flow, which is close to the hardware environment with a flexible scenario coverage, then transformed and applied to the first simulation to achieve the fast execution speed.

The proposed approach may greatly improve the efficiency of firmware validation in pre-silicon stage, in particular by providing a highly reliable regression test environment to improve the firmware quality during new feature development and bug fixing. With the proposed concept, the product development may be shifted left, thus helping to meet the customer requirements for both quality and schedule. The proposed concept is particularly suitable for validating silicon firmware which requires data transaction between the silicon IP block and external devices, such as memory or PCIe (Peripheral Component Interconnect express) training, by providing a hybrid way to balance efficiency and cost.

The present disclosure relate to the kind of simulation methodology being used in pre-silicon validation. For the simulation environment which has the silicon logic implementation, the transaction data among silicon IP may be recorded and saved from the execution of the simulation. For the simulation environment that has the register interface implemented without the silicon logic, external transaction data is deployed into the system to drive the execution flow. A typical usage scenario according to the proposed concept is that the (flow of transaction) data is recorded from the silicon logic simulation environment and played back in the register interface simulation environment.

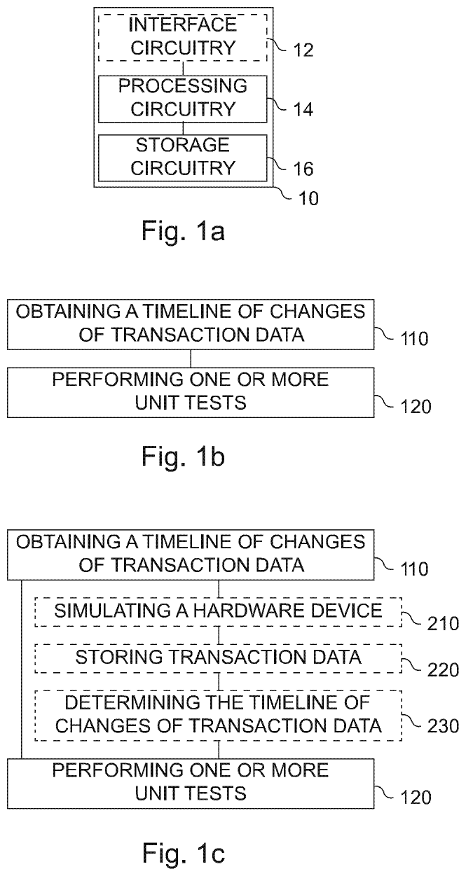

FIG. 1a shows a block diagram of an example of an apparatus 10 or device 10 for performing unit tests on firmware code, with the firmware code being suitable for interacting with a hardware device. The apparatus 10 comprises circuitry, configured to perform the functionality of the apparatus 10. For example, the apparatus 10 may comprise processing circuitry 14 and storage circuitry 16. Optionally, the apparatus 10 may further comprise interface circuitry 12. The processing circuitry 14 is coupled with the interface circuitry 12 and with the storage circuitry 16. For example, the processing circuitry 14 may be configured to provide the functionality of the apparatus 10, e.g., in conjunction with the interface circuitry 12 (for exchanging data/information) and/or with the storage circuitry 16 (for storing information). Accordingly, the corresponding device 10 comprises means that are configured to perform the functionality of the device 10. For example, the corresponding device 10 may comprise means for processing 14, which may be implemented by the processing circuitry 14, means for communicating 12, which may be implemented by the interface circuitry 12, and means for storing information 16, which may be implemented by the storage circuitry 16. The components of the device 10 are defined as component means, which may be implemented by the respective structural components of the apparatus 10.

The circuitry/means is configured to obtain a timeline of changes of transaction data encountered at one or more interfaces of the hardware device during simulation of the hardware device. The simulation is based on one or more simulation parameters defined by one or more unit tests to be performed on the firmware code. The circuitry/means is configured to perform the one or more unit tests of the firmware code using the timeline of changes of transaction data of the simulated hardware device. The one or more unit tests are based on the one or more simulation parameters.

FIGS. 1b and 1c show flow charts of examples of a corresponding method for performing unit tests on firmware code. The method comprises obtaining 110 the timeline of changes of transaction data encountered at one or more interfaces of the hardware device during simulation of the hardware device. The simulation is based on the one or more simulation parameters defined by one or more unit tests to be performed on the firmware code. The method comprises performing 120 the one or more unit tests of the firmware code using the timeline of changes of transaction data of the simulated hardware device. The one or more unit tests are based on the one or more simulation parameters.

In the following, the functionality of the apparatus 10, device 10, method and of a corresponding computer program are described with respect to the apparatus 10. Features described with respect to the apparatus 10 may likewise be included in the corresponding device, method, and computer program.

Various examples of the present disclosure relate to the apparatus 10, device 10, method and computer program for performing unit tests on firmware code that is suitable for interacting with a hardware device. In particular, as outlined above, the proposed concept may leverage the properties of the afore-mentioned first and second simulation to provide improved performance and coverage for unit tests in pre-silicon firmware development.

The proposed concept is applied at the boundary between software and hardware—it is used to perform unit tests on firmware, with the firmware being used to manage and/or access the hardware. For example, the firmware may correspond to, or implement a subsystem of, the Unified Extensible Firmware Interface (UEFI) or of the Basic Input/Output System (BIOS) of a computer system. However, examples are not limited to this scenario—the proposed concept is suitable for various types of firmware that rely on the interaction with hardware.

In general, the afore-mentioned firmware interacts with the hardware device. For this purpose, (hardware) registers may be exposed by the hardware device, which may be written to and/or read from by the firmware. Hardware registers are typically implemented using flip-flops, and may be implemented similar to memory, but with additional hardware-based functionality that is controlled via the register. In various examples of the present disclosure, it is assumed that the firmware under tests interacts with the hardware device via one or more registers. Accordingly, the hardware device is modeled, as part of the simulation, via the data written into the one or more registers and/or read from the one or more registers. In other words, independent of whether the first or second simulation is performed, the interaction is performed via the one or more registers. In this case, the one or more registers may correspond to the interface or interfaces of the hardware device. Accordingly, the changes to the one or more registers that occur during a test case (which may correspond to the test cases occurring during the one or more unit tests) are recorded and replayed for use with the first simulation. This goes beyond the approach used in some other systems, where static responses are provided via the (simulated) registers of the hardware device. Moreover, this feature may enable the extended coverage that stems from different test parameters being applied to the second and first simulation.

The circuitry is configured to obtain the timeline of changes of transaction data encountered at the one or more interfaces of the hardware device during simulation of the hardware device, with the simulation being based on one or more simulation parameters defined by one or more unit tests to be performed on the firmware code. In other words, the transaction data is based on a simulation of the hardware device. The simulation, in turn, is based on one or more simulation parameters. These simulation parameters correspond to those to be used during the one or more unit tests that are to be performed on the firmware code. Accordingly, the simulation of the hardware device is tailored to the one or more unit tests that are to be performed on the firmware code. With respect to the terminology being used before, the simulation being used to obtain the timeline of changes of transaction data corresponds to the afore-mentioned “second simulation”, and the one or more unit tests are use the “first simulation” mentioned above, albeit incorporating the timeline of changes of the transaction data determined using the “second simulation”. For example, the transaction data is data that is relevant for the firmware, e.g., that is read by and/or written by (i.e., accessed by) the firmware device. For example, the timeline of changes of the transaction data encountered at the one or more interfaces of the hardware device may be an abstract representation of a behavior of the hardware device to be encountered during the one or more unit tests.

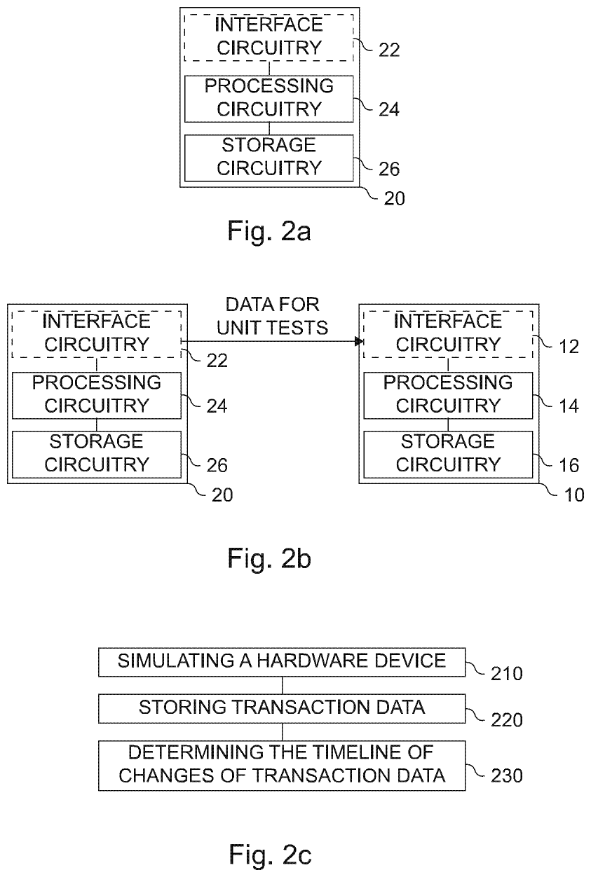

While the simulation of the hardware device (to obtain the timeline of changes of transaction data) is not necessarily performed by the apparatus 10, it can be in some examples. Alternatively, the simulation of the hardware device (to obtain the timeline of changes of transaction data) may be performed by a separate device, such as the apparatus 20 or device 20 introduced in connection with FIG. 2a.

Accordingly, the circuitry may be configured to obtain the timeline of changes of the transaction data by simulating the hardware device based on the one or more simulation parameters, storing transaction data encountered at one or more interfaces of the hardware device during simulation of the hardware device (e.g., using the storage circuitry), and determining the timeline of changes of the transaction data based on the stored transaction data. Accordingly, as shown in FIG. 1c, the timeline of changes of the transaction data may be obtained by simulating 210 the hardware device based on the one or more simulation parameters, storing 220 transaction data encountered at one or more interfaces of the hardware device during simulation of the hardware device, and determining 230 the timeline of changes of the transaction data based on the stored transaction data.

During simulation, the state of the simulated hardware device is monitored and recorded to determine the timeline of changes to the transaction data. Assuming that the hardware device is accessed by the firmware via one or more registers, the internal state of the hardware device may be of less interest than the “external” state of the hardware device, i.e., the content of the one or more registers. For example, the firmware code may interact with the hardware device via one or more registers of the hardware device. Accordingly, the timeline of changes of the transaction data may represent changes of a state or content of the one or more registers of the hardware device over time. For example, the act of storing the transaction data may comprise storing a content of one or more registers of the simulated hardware device encountered during simulation. For example, the transaction data, i.e., the state or content of the one or more registers, may be stored together with a timestamp indicating when a change of the transaction data/state or content of the register occurred. For example, at the beginning, a snapshot of the state or content of the one or more registers may be determined, and each change to a register of the one or more registers may be stored, to be used for determining the timeline of changes of the transaction data. The act of determining the timeline of changes of the transaction data may accordingly comprise determining a timeline of state or content changes of the one or more registers of the simulated hardware device (based on the stored state or content changes and the corresponding timestamps).

As has been outlined before, the “internal” state of the hardware device may be irrelevant for the subsequent unit tests of the firmware code—therefore, it may be discarded. Moreover, not every register of the hardware device may be used for interacting with the firmware (or with another hardware device that is coupled with the hardware device), some might only be status registers that are of no relevance for the one or more unit tests. Therefore, the one or more registers being recorded may be registers that are accessed by the one or more unit tests. For example, a register that is only used in another context, e.g., for a reset procedure that is not part of the one or more unit tests, may be disregarded, its state or content not stored, which may reduce the complexity of the timeline of changes of the transaction data.

In general, the timeline of changes of the transaction data may be stored in a data format that is accessible for a simulator being used for performing the one or more unit tests. For example, a list of changes of the transaction data may be stored, with the list comprising a chronological list of changes of the one or more registers.

As outlined above, the simulation of the hardware device is akin to the second simulation, i.e., a representation of the hardware device that models the functionality of the hardware device is simulated. There are various approaches to performing such a simulation. For example, the hardware device may be specified using code that represents the functionality of the hardware device, i.e., that models the (internal) operation of the hardware device. Accordingly, the hardware device may be simulated based on code specifying the functionality (e.g., including the inner workings/state) of the hardware device. For example, the code may be based on a hardware description language, such as Verilog, System Verilog or VHDL (Very High Speed Integrated Circuit Hardware Description Language). Alternatively, the code may be converted into a register transfer level representation, and the register level representation may be used to simulate the hardware device. Alternatively, a netlist representation, which may be a post-synthesis netlist or a pre-synthesis netlist, may be used to perform the simulation. In other words, the hardware device may be simulated based on a register transfer layer representation or a netlist representation of the hardware device. As another option, actual hardware may be used to perform the simulation. For example, the functionality of the hardware device may be modeled using an FPGA, or an existing implementation of the hardware device may be used to simulate the hardware device. Accordingly, the hardware device may be simulated using a field-programmable gate array or using an existing hardware implementation of the hardware device. In this context, the term “simulating the hardware device” indicates, that a software facsimile of the hardware device is created, which is later used for the one or more unit tests.

As outlined earlier, the same one or more simulation parameters are used for simulating the hardware device and for performing the one or more unit tests (which is based on another simulation that takes into account the simulation of the hardware device. Various simulation parameters may be set in unison for the simulation of the hardware device and for the one or more unit tests. For example, the one or more simulation parameters may comprise at least one simulation parameter related to a setting of the hardware device, e.g., a transfer rate etc. Additionally or alternatively, the one or more simulation parameters may comprise at least one simulation parameter that is related to a software setting controlling the behavior of the hardware device, such as a driver setting. Finally, external settings may be taken into account. For example, as outlined earlier, the hardware device may be a memory controller for interfacing with one or more memory modules via one or more memory module slots. The simulation and the one or more unit tests may be based on the population of the memory module slots, e.g., which type of memory module is inserted into which memory module slot. In other words, the one or more simulation parameters may comprise at least one simulation parameter related to a population of the one or more memory module slots. However, the same concept may be used for other types of hardware devices that are controlled via firmware, e.g., graphics processing units, accelerator cards, network interfaces and the like.

Once the timeline of changes of transaction data is obtained, e.g., by simulation or from an external apparatus/device, it can be used as part of the one or more unit tests. A unit test is a software-defined test, which is used to verify that a piece of software (or hardware) yields an expected result based on a given set of parameters. In general, unit tests are defined to cover all or most of the use cases and edge cases of a piece of hardware or software, and are run automatically against a codebase of software, such as the firmware code or against a hardware device. In general, each unit test comprises a set of parameters that are used to call a function of the software or an operation of a hardware, with the result of the function or operation being compared with the expected result of the unit test. If the result corresponds to the expected result, the unit test passes, else it fails.

For example, the circuitry is configured to perform the one or more unit tests of the firmware code using the timeline of changes of the transaction data of the simulated hardware device, with the one or more unit tests being based on the one or more simulation parameters. For example, the one or more unit tests may be performed using one or more further simulations, with the timeline of changes of the transaction data being used to model the behavior of the hardware device. In other words, the one or more unit tests may be based on one or more further simulations, with the one or more further simulations being based on the timeline of changes of the transaction data. For example, the timeline of changes of the transaction data may be played back within the one or more unit tests (as response of the hardware device in the one or more further modulations) to model the (external) behavior of the hardware device. Accordingly, in contrast to the “first simulation” introduced in the beginning, the transaction data is not provided statically in the one or more function simulations but is played back dynamically based on the prior simulation of the hardware device.

As outlined earlier, the firmware code may interface with the hardware device via the one or more registers of the hardware device. Accordingly, the one or more unit tests may be performed using the changes of the state or content of the one or more registers of the hardware device over time. In other words, the one or more unit tests may be performed using the timeline of state or content changes of the one or more registers of the simulated hardware device.

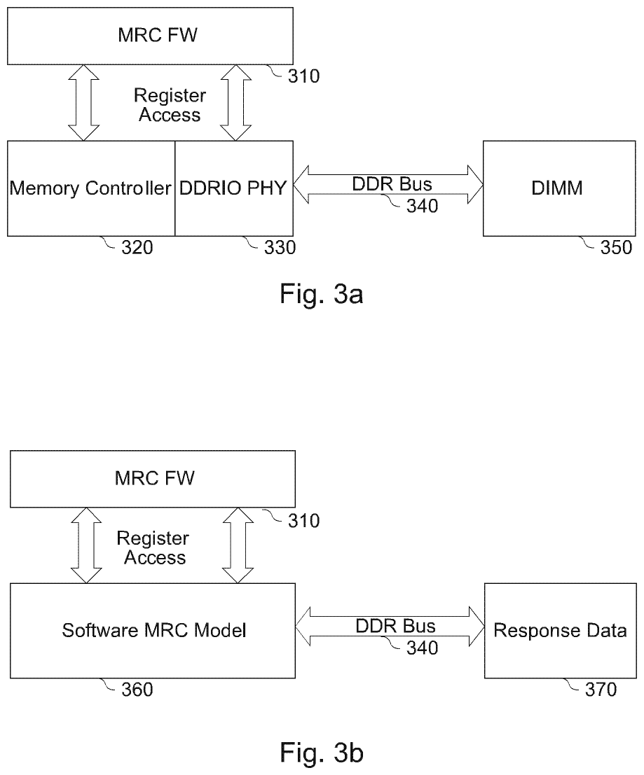

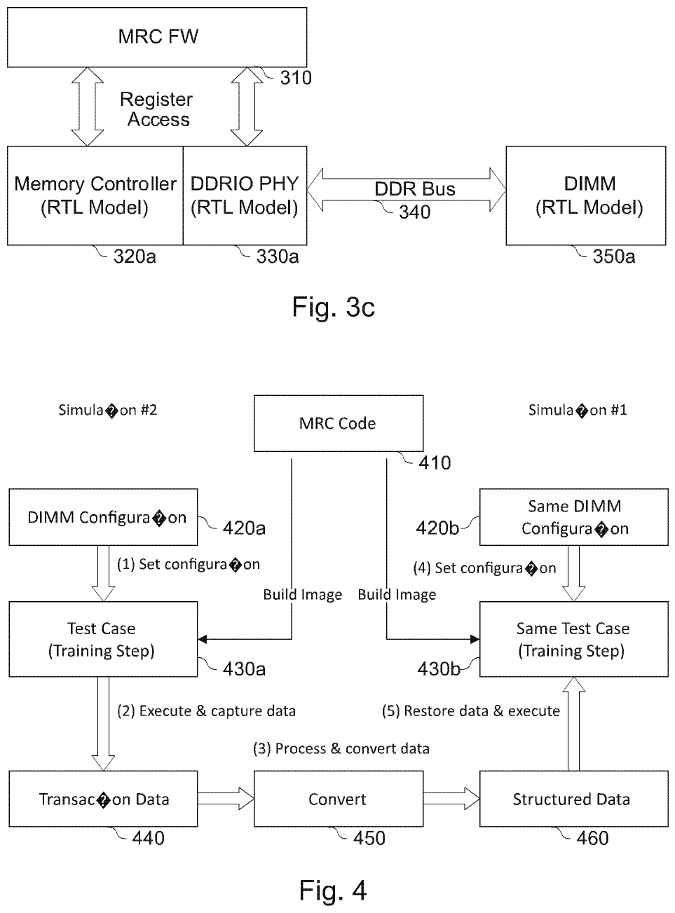

As will be shown in more detail with respect to FIGS. 3a to 5b, the proposed concept may in particular be used for the validation of firmware for accessing a memory controller. Accordingly, the hardware device may be a memory controller for interfacing with one or more memory modules via one or more memory module slots. For example, the one or more unit tests may relate to an electronic signal training flow for initializing the one or more memory modules. In an electronic signal training flow, a signal timing is adjusted to the access time and response time of the memory. For example, the timeline of changes of the transaction data may relate to a response of the one or more memory modules to an electronic training signal provided by the memory controller. In other words, the simulation of the hardware device models a response of the combination of the memory controller and the memory to the execution of the electronic signal training flow. Accordingly, values of the one or more registers of the timeline of changes may indicate a result of a training of the one or more memory modules.

In the present disclosure, a simulation is performed, which is based on one or more simulation parameters, with the simulation being used for one or more unit tests. In some cases, it may be beneficial to vary the simulation parameters, so that a larger variety of unit tests can be performed. Accordingly, the simulation may be performed using a plurality of sets of one or more simulation parameters. Consequently, the one or more unit tests may be based on the (same) plurality of set of one or more simulation parameters. In other words, multiple sets of one or more simulation parameters may be used to support a large variety of unit tests.

As an example, the hardware device may be a memory controller for interfacing with one or more memory modules via one or more memory module slots. Multiple sets of one or more parameters may be used to cover various aspects of the memory controller, e.g., multiple different populations of the one or more memory module slots, or multiple different training patterns (including multiple different timings of the training patterns). In other words, the one or more unit tests may relate to the electrical signal training flow for initializing the one or more memory modules. For example, the plurality of sets of one or more simulation parameters are based on a plurality of training patterns being used for performing the electrical signal training flow.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 10, device 10, method and computer program are mentioned in connection with the proposed concept or one or more examples described above or below (e.g. FIG. 2a to 5b). The apparatus 10, device 10, method and computer program may comprise one or more additional optional features corresponding to one or more aspects of the proposed concept or one or more examples described above or below.

FIG. 2a shows a block diagram of an example of an apparatus 20 or device 20 for preparing data for performing unit tests on firmware code. For example, the apparatus 20 or device 20 may be implemented similar to the apparatus 10 or device 10 of FIG. 1a. For example, the apparatus 20 or device 20 may focus on the simulation aspect outlined in connection with FIGS. 1a to 1c.

The apparatus 20 comprises circuitry, configured to perform the functionality of the apparatus 20. For example, the apparatus 20 may comprise processing circuitry 24 and storage circuitry 26. Optionally, the apparatus 20 may further comprise interface circuitry 22. The processing circuitry 24 is coupled with the interface circuitry 22 and with the storage circuitry 26. For example, the processing circuitry 24 may be configured to provide the functionality of the apparatus 20, e.g., in conjunction with the interface circuitry 22 (for exchanging data/information) and/or with the storage circuitry 26 (for storing information). Accordingly, the corresponding device 20 comprises means that are configured to perform the functionality of the device 20. For example, the corresponding device 20 may comprise means for processing 24, which may be implemented by the processing circuitry 24, means for communicating 22, which may be implemented by the interface circuitry 22, and means for storing information 26, which may be implemented by the storage circuitry 26. The components of the device 20 are defined as component means, which may be implemented by the respective structural components of the apparatus 20.

The circuitry/means is configured to simulate the hardware device based on one or more simulation parameters, the one or more simulation parameters being defined by one or more unit tests to be performed on the firmware code. The circuitry/means is configured to store transaction data encountered at one or more interfaces of the hardware device during simulation of the hardware device. The circuitry/means is configured to determine a timeline of changes of the transaction data encountered at the one or more interfaces of the hardware device.

FIG. 2b shows a block diagram of an example of a system comprising the apparatus or device 20 for preparing data for performing unit tests on firmware code and the apparatus or device 10 for performing unit tests on firmware code, as shown in connection with FIGS. 1a to 1c.

FIG. 2c shows a flow chart of an example of a corresponding method for preparing data suitable for performing unit tests on firmware code. The method comprises simulating 210 the hardware device based on the one or more simulation parameters, with the one or more simulation parameters being defined by one or more unit tests to be performed on the firmware code. The method comprises storing 220 the transaction data encountered at one or more interfaces of the hardware device during simulation of the hardware device. The method comprises determining 230 the timeline of changes of the transaction data encountered at the one or more interfaces of the hardware device.

As becomes evident, the apparatus 20, device 20, method and computer program of FIGS. 2a to 2c relate to the aspect of the apparatus 10, device 10, method and computer program of FIGS. 1a to 1c that performs the simulation to obtain the timeline of changes of the transaction data. The respective functionality thus has already been introduced in connection with FIGS. 1a to 1c. In particular, as has been introduced in connection with FIGS. 1a to 1c, the act of storing the transaction data may comprise storing a state or content of one or more registers of the simulated hardware device encountered during simulation. For example, the act of determining the timeline of changes of the transaction data may comprise determining a timeline of state or content changes of the one or more registers of the simulated hardware device. For example, the one or more unit tests may be performed using the timeline of state or content changes of the one or more registers of the simulated hardware device.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general purpose processor, a Digital Signal Processor (DSP), a micro-controller, etc.

For example, the storage circuitry 26 may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, method and computer program are mentioned in connection with the proposed concept or one or more examples described above or below (e.g. FIG. 1a to 1c, 3a to 5b). The apparatus 20, device 20, method and computer program may comprise one or more additional optional features corresponding to one or more aspects of the proposed concept or one or more examples described above or below.

In the following, the proposed concept is illustrated with respect to MRC validation. The Memory Reference Code subsystem is one of the biggest IP modules in the UEFI (Unified Extensible Firmware Interface) firmware which is used to initialize the memory subsystem during boot process. The major function of the MRC subsystem may be to train the memory signals for data access and create the memory map between physical address and logical address for OS to use. For memory training, the basic approach is to configure the registers of the MC (Memory Controller) and DDRIO PHY to adjust the signal delay and voltage, etc., then check the response signal values and adjust the register settings accordingly, until the signals can be correctly captured from both the MC side and the DIMM side with good margins. The architecture can be abstracted as shown in FIG. 3a FIG. 3a shows a schematic diagram of a memory reference code subsystem. FIG. 3a shows the MRC firmware 310, which communicates via register access with the memory controller 320 and the DDRIO PHY 330. The DDRIO PHY 330 communicates with the DIMM 350 via the DDR Bus 340.

In the pre-silicon stage, the silicon IP blocks are often not available, so in the first simulation, which is performed using simulators such as Simics and RcSim, both MC and DDRIO PHY 320; 330 are implemented as software models 360 with the register access behavior implemented as black boxes. FIG. 3b shows a schematic diagram of a memory reference code subsystem with a black-box simulation. The DIMM side 350 is replaced by a series of pre-defined data structures (of response data 370) to provide the transaction flow on the DDR Bus 330.

However, as described previously, with this approach, the Response Data can just provide limited samples to drive the electrical signal training flow, such as a good-shaped eye-diagram for a data signal and may lack of the capability to generate complex signal changes as HW device in post silicon stage, such as the signal dithering, distortion, or interference. Considering the number of signals and training steps, it is infeasible to enumerate all the possible scenarios in real world to achieve a high software test coverage in pre-silicon.

In the second simulation, all the silicon IPs are implemented as white boxes with hardware description language such as System-Verilog and built/wrapped to provide the same register interface for MRC firmware to invoke. FIG. 3c shows a schematic diagram of a memory reference code subsystem with a white-box simulation, where all the IP blocks are replaced with the silicon simulation models. For example, the Memory Controller 320 is replaced by an RTL model 320a of the Memory Controller, the DDRIO PHY 330 is replaced by an RTL model 330a of the DDRIO PHY 330, and the DIMM 350 is replaced with an RTL model 350a of the DIMM 350. In this model, the data transaction between MC/DDRIO and the DIMM can fully simulate the sequence, patterns, and values in the silicon platform, thus is close to the real-world situation with the end to end flow.

In FIG. 3c, the RTL (Register Transfer Level) model is the abstraction of digital circuit in terms of digital signal flows and the logical operations on registers, it can behave just like the silicon model for the memory training process. This may provide a comprehensive approach for testing both silicon design and firmware implementation, however it is computationally expensive and/or slow.

To leverage the advantages of both simulations, the proposed concept provides a “Record and Restore” methodology to capture the data from the second simulation and feed the data into the first simulation. For example, the flow may comprise one or more of the following tasks:
(1) Specify a configuration including hardware settings, software settings, DIMM populations, etc.
(2) Run a test case with the configuration in the second simulation and capture the transaction data flow. In the present example, a test case is a memory training step, the transaction data is the response from DIMM to MC, which is the register values indicating the signal result tested under certain training patterns.
(3) Convert the data into the pre-defined format which can be consumed by the first simulation. In the present example, the recorded register values may be structured into multi-dimension arrays in a file. The data in the array may represent the signal from the respective slot, channel, ranks, or bit, determined by each specific training step.
(4) Set the same test configuration for the first simulation and run the same test case.
(5) During test execution on the first simulation, read the data prepared in (3) and feed the data into the firmware when it needs response from the registers. This way, the same pass/fail result as in the second simulation can be obtained at a high speed.

With respect to MRC validation, a typical usage of this flow is shown in FIG. 4a below diagram: FIG. 4 shows a schematic diagram outlining a flow of data in a deployment for memory reference code validation. On the left side, the second simulation is shown, on the right side, the first simulation is shown.

Both the first simulation and the second simulation are using the same DIMM configuration 420a; 420b being set (1, 4) and executing (2, 5) the same training step 430a; 430b. The MRC code 410 is used to generate a build image that is used in the respective training steps 430a; 430b. The transaction data 440 of the execution (2) of the training step 430a is processed and converted (3) 450 to determine structured data 460. With the data recorded and managed, all the training steps (or called test cases) from the second simulation can be replicated in the first simulation (by restoring the data and executing the test case), so both the developer and validation teams can work on this model for regression test, unit test and bug investigation. They can benefit from the fast execution speed and more debug capabilities provide by the first simulation, meanwhile also have a full training flow coverage from firmware/software perspective as the second simulation to detect and reproduce the issue.

For example, the memory training has one component to train the data signals (also known as data quality training, DQ). When performing this training in the second simulation, the data may be captured from the system log and translated as a pre-defined table format.

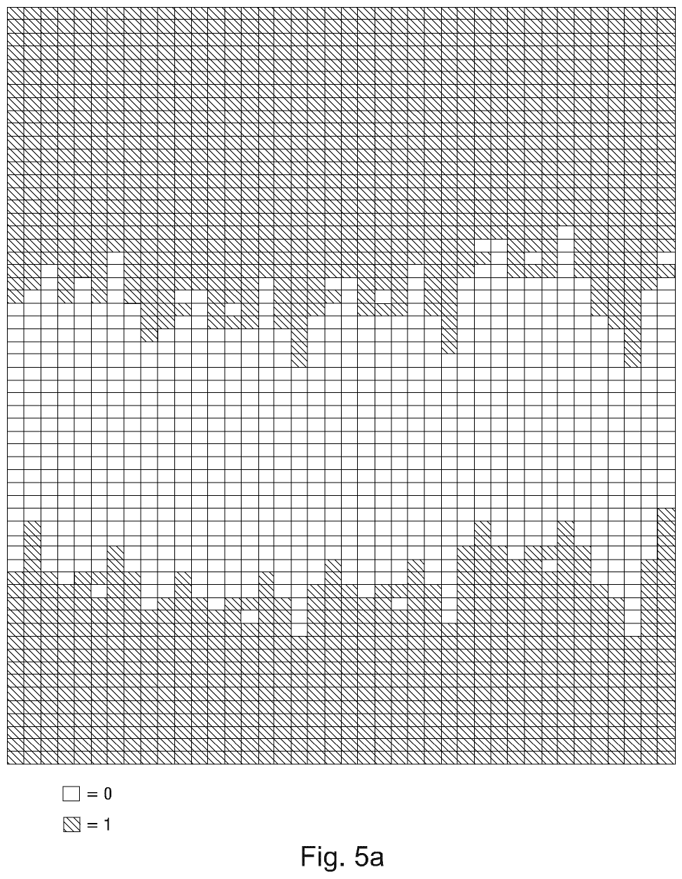

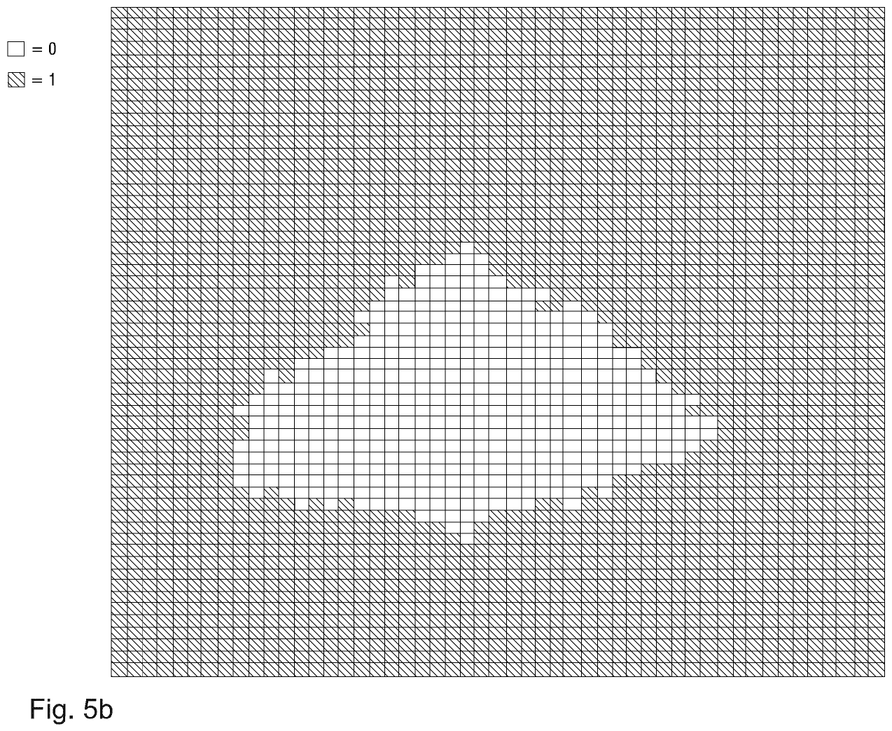

An example for such captured data is shown in FIGS. 5a and 5b. FIGS. 5a and 5b show a schematic representation of training data (FIG. 5a) and result (FIG. 5b) of captured transaction data. FIG. 5a shows, as columns, the training data for all 40 bits (one sub-channel of DDR5) for different training codes (rows). As indicated by the lack of fill in the middle, the middle training codes (e.g., training codes 27 to 38) do not exhibit errors (i.e., they pass), while the other training codes partially generate errors in some of the bits (i.e., they fail). FIG. 5b shows an eye-diagram of the time sweeping result for one data bit. These tables may be converted to data structures (multi-dimension tables) that the first simulation can use to run the electrical signal training flows.

Moreover, the MRC training data may also be captured from an existing hardware platform and be applied on the first simulation to reduce the hardware cost or duplicate customer issues. This methodology can greatly increase the validation and development speed in pre-silicon, detect and fix the bugs earlier. The recorded data and test cases developed in the current generation product can also be applied in the next generation for the derivative features' validation, thus can even more contribute to accelerating the pre-silicon development for next gen products.

The aspects and features described in relation to a particular one of the previous examples may also be combined with one or more of the further examples to replace an identical or similar feature of that further example or to additionally introduce the features into the further example.

An example (e.g., example 1) relates to an apparatus (10) for performing unit tests on firmware code, the firmware code being suitable for interacting with a hardware device, the apparatus comprising circuitry configured to obtain a timeline of changes of transaction data encountered at one or more interfaces of the hardware device during simulation of the hardware device, the simulation being based on one or more simulation parameters defined by one or more unit tests to be performed on the firmware code. The circuitry is configured to perform the one or more unit tests of the firmware code using the timeline of changes of transaction data of the simulated hardware device, the one or more unit tests being based on the one or more simulation parameters.

Another example (e.g., example 2) relates to a previously described example (e.g., example 1) or to any of the examples described herein, further comprising that the firmware code interacts with the hardware device via one or more registers of the hardware device.

Another example (e.g., example 3) relates to a previously described example (e.g., example 2) or to any of the examples described herein, further comprising that the timeline of changes of the transaction data represent changes of a state or content of the one or more registers of the hardware device over time, wherein the one or more unit tests are performed using the changes of the state or content of the one or more registers of the hardware device over time.

Another example (e.g., example 4) relates to a previously described example (e.g., one of the examples 1 to 3) or to any of the examples described herein, further comprising that the timeline of changes of the transaction data encountered at the one or more interfaces of the hardware device is an abstract representation of a behavior of the hardware device to be encountered during the one or more unit tests.

Another example (e.g., example 5) relates to a previously described example (e.g., one of the examples 1 to 4) or to any of the examples described herein, further comprising that the one or more simulation parameters comprise at least one simulation parameter related to a setting of the hardware device.

Another example (e.g., example 6) relates to a previously described example (e.g., one of the examples 1 to 5) or to any of the examples described herein, further comprising that the one or more simulation parameters comprise at least one simulation parameter related to a software setting controlling the behavior of the hardware device.

Another example (e.g., example 7) relates to a previously described example (e.g., one of the examples 1 to 6) or to any of the examples described herein, further comprising that the hardware device is a memory controller for interfacing with one or more memory modules via one or more memory module slots, wherein the one or more simulation parameters comprise at least one simulation parameter related to a population of the one or more memory module slots.

Another example (e.g., example 8) relates to a previously described example (e.g., one of the examples 1 to 7) or to any of the examples described herein, further comprising that the hardware device is simulated based on code specifying the functionality of the hardware device, the code being based on a hardware description language.

Another example (e.g., example 9) relates to a previously described example (e.g., one of the examples 1 to 7) or to any of the examples described herein, further comprising that the hardware device is simulated based on a register transfer layer representation or a netlist representation of the hardware device.

Another example (e.g., example 10) relates to a previously described example (e.g., one of the examples 1 to 7) or to any of the examples described herein, further comprising that the hardware device is simulated using a field-programmable gate array or using an existing hardware implementation of the hardware device.

Another example (e.g., example 11) relates to a previously described example (e.g., one of the examples 1 to 10) or to any of the examples described herein, further comprising that the hardware device is a memory controller for interfacing with one or more memory modules via one or more memory module slots.

Another example (e.g., example 12) relates to a previously described example (e.g., example 11) or to any of the examples described herein, further comprising that the one or more unit tests relate to an electronic signal training flow for initializing the one or more memory modules.

Another example (e.g., example 13) relates to a previously described example (e.g., one of the examples 11 to 12) or to any of the examples described herein, further comprising that the timeline of changes of the transaction data relates to a response of the one or more memory modules to an electronic training signal provided by the memory controller.

Another example (e.g., example 14) relates to a previously described example (e.g., example 13) or to any of the examples described herein, further comprising that the timeline of changes of the transaction data comprises a timeline of state or content changes of one or more registers of the simulated hardware device, with values of the one or more registers indicating a result of a training of the one or more memory modules.

Another example (e.g., example 15) relates to a previously described example (e.g., one of the examples 1 to 14) or to any of the examples described herein, further comprising that the simulation is performed using a plurality of sets of one or more simulation parameters.

Another example (e.g., example 16) relates to a previously described example (e.g., example 15) or to any of the examples described herein, further comprising that the hardware device is a memory controller for interfacing with one or more memory modules via one or more memory module slots, wherein the one or more unit tests relate to an electrical signal training flow for initializing the one or more memory modules, wherein the plurality of sets of one or more simulation parameters are based on a plurality of training patterns being used for performing the electrical signal training flow.

Another example (e.g., example 17) relates to a previously described example (e.g., one of the examples 1 to 16) or to any of the examples described herein, further comprising that the circuitry is configured to obtain the timeline of changes of the transaction data by simulating the hardware device based on the one or more simulation parameters, storing transaction data encountered at one or more interfaces of the hardware device during simulation of the hardware device, and determining the timeline of changes of the transaction data based on the stored transaction data.

Another example (e.g., example 18) relates to a previously described example (e.g., example 17) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 19) relates to an apparatus (10; 20) for preparing data suitable for performing unit tests on firmware code, the firmware code being suitable for interacting with a hardware device, the apparatus comprising circuitry configured to simulate the hardware device based on one or more simulation parameters, the one or more simulation parameters being defined by one or more unit tests to be performed on the firmware code.

The circuitry is configured to store transaction data encountered at one or more interfaces of the hardware device during simulation of the hardware device. The circuitry is configured to determine a timeline of changes of the transaction data encountered at the one or more interfaces of the hardware device.

Another example (e.g., example 20) relates to a previously described example (e.g., example 19) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 21) relates to a device (10) for performing unit tests on firmware code, the firmware code being suitable for interacting with a hardware device, the device comprising means configured to obtain a timeline of changes of transaction data encountered at one or more interfaces of the hardware device during simulation of the hardware device, the simulation being based on one or more simulation parameters defined by one or more unit tests to be performed on the firmware code. The means is configured to perform the one or more unit tests of the firmware code using the timeline of changes of transaction data of the simulated hardware device, the one or more unit tests being based on the one or more simulation parameters.

Another example (e.g., example 22) relates to a previously described example (e.g., example 21) or to any of the examples described herein, further comprising that the firmware code interacts with the hardware device via one or more registers of the hardware device.

Another example (e.g., example 23) relates to a previously described example (e.g., example 22) or to any of the examples described herein, further comprising that the timeline of changes of the transaction data represent changes of a state or content of the one or more registers of the hardware device over time, wherein the one or more unit tests are performed using the changes of the state or content of the one or more registers of the hardware device over time.

Another example (e.g., example 24) relates to a previously described example (e.g., one of the examples 21 to 23) or to any of the examples described herein, further comprising that the timeline of changes of the transaction data encountered at the one or more interfaces of the hardware device is an abstract representation of a behavior of the hardware device to be encountered during the one or more unit tests.

Another example (e.g., example 25) relates to a previously described example (e.g., one of the examples 21 to 24) or to any of the examples described herein, further comprising that the one or more simulation parameters comprise at least one simulation parameter related to a setting of the hardware device.

Another example (e.g., example 26) relates to a previously described example (e.g., one of the examples 21 to 25) or to any of the examples described herein, further comprising that the one or more simulation parameters comprise at least one simulation parameter related to a software setting controlling the behavior of the hardware device.

Another example (e.g., example 27) relates to a previously described example (e.g., one of the examples 21 to 26) or to any of the examples described herein, further comprising that the hardware device is a memory controller for interfacing with one or more memory modules via one or more memory module slots, wherein the one or more simulation parameters comprise at least one simulation parameter related to a population of the one or more memory module slots.

Another example (e.g., example 28) relates to a previously described example (e.g., one of the examples 21 to 27) or to any of the examples described herein, further comprising that the hardware device is simulated based on code specifying the functionality of the hardware device, the code being based on a hardware description language.

Another example (e.g., example 29) relates to a previously described example (e.g., one of the examples 21 to 27) or to any of the examples described herein, further comprising that the hardware device is simulated based on a register transfer layer representation or a netlist representation of the hardware device.

Another example (e.g., example 30) relates to a previously described example (e.g., one of the examples 21 to 27) or to any of the examples described herein, further comprising that the hardware device is simulated using a field-programmable gate array or using an existing hardware implementation of the hardware device.

Another example (e.g., example 31) relates to a previously described example (e.g., one of the examples 21 to 30) or to any of the examples described herein, further comprising that the hardware device is a memory controller for interfacing with one or more memory modules via one or more memory module slots.

Another example (e.g., example 32) relates to a previously described example (e.g., example 31) or to any of the examples described herein, further comprising that the one or more unit tests relate to an electronic signal training flow for initializing the one or more memory modules.

Another example (e.g., example 33) relates to a previously described example (e.g., one of the examples 31 to 32) or to any of the examples described herein, further comprising that the timeline of changes of the transaction data relates to a response of the one or more memory modules to an electronic training signal provided by the memory controller.

Another example (e.g., example 34) relates to a previously described example (e.g., example 33) or to any of the examples described herein, further comprising that the timeline of changes of the transaction data comprises a timeline of state or content changes of one or more registers of the simulated hardware device, with values of the one or more registers indicating a result of a training of the one or more memory modules.

Another example (e.g., example 35) relates to a previously described example (e.g., one of the examples 21 to 34) or to any of the examples described herein, further comprising that the simulation is performed using a plurality of sets of one or more simulation parameters.

Another example (e.g., example 36) relates to a previously described example (e.g., example 35) or to any of the examples described herein, further comprising that the hardware device is a memory controller for interfacing with one or more memory modules via one or more memory module slots, wherein the one or more unit tests relate to an electrical signal training flow for initializing the one or more memory modules, wherein the plurality of sets of one or more simulation parameters are based on a plurality of training patterns being used for performing the electrical signal training flow.

Another example (e.g., example 37) relates to a previously described example (e.g., one of the examples 21 to 36) or to any of the examples described herein, further comprising that the means is configured to obtain the timeline of changes of the transaction data by simulating the hardware device based on the one or more simulation parameters, storing transaction data encountered at one or more interfaces of the hardware device during simulation of the hardware device, and determining the timeline of changes of the transaction data based on the stored transaction data.

Another example (e.g., example 38) relates to a previously described example (e.g., example 37) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 39) relates to a device (10; 20) for preparing data suitable for performing unit tests on firmware code, the firmware code being suitable for interacting with a hardware device, the device comprising means configured to simulate the hardware device based on one or more simulation parameters, the one or more simulation parameters being defined by one or more unit tests to be performed on the firmware code. The means is configured to store transaction data encountered at one or more interfaces of the hardware device during simulation of the hardware device. The means is configured to determine a timeline of changes of the transaction data encountered at the one or more interfaces of the hardware device.

Another example (e.g., example 40) relates to a previously described example (e.g., example 39) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 41) relates to a method for performing unit tests on firmware code, the firmware code being suitable for interacting with a hardware device, the method comprising obtaining (110) a timeline of changes of transaction data encountered at one or more interfaces of the hardware device during simulation of the hardware device, the simulation being based on one or more simulation parameters defined by one or more unit tests to be performed on the firmware code. The method comprises performing (120) the one or more unit tests of the firmware code using the timeline of changes of transaction data of the simulated hardware device, the one or more unit tests being based on the one or more simulation parameters.

Another example (e.g., example 42) relates to a previously described example (e.g., example 41) or to any of the examples described herein, further comprising that the firmware code interacts with the hardware device via one or more registers of the hardware device.

Another example (e.g., example 43) relates to a previously described example (e.g., example 42) or to any of the examples described herein, further comprising that the timeline of changes of the transaction data represent changes of a state or content of the one or more registers of the hardware device over time, wherein the one or more unit tests are performed using the changes of the state or content of the one or more registers of the hardware device over time.

Another example (e.g., example 44) relates to a previously described example (e.g., one of the examples 41 to 43) or to any of the examples described herein, further comprising that the timeline of changes of the transaction data encountered at the one or more interfaces of the hardware device is an abstract representation of a behavior of the hardware device to be encountered during the one or more unit tests.

Another example (e.g., example 45) relates to a previously described example (e.g., one of the examples 41 to 44) or to any of the examples described herein, further comprising that the one or more simulation parameters comprise at least one simulation parameter related to a setting of the hardware device.

Another example (e.g., example 46) relates to a previously described example (e.g., one of the examples 41 to 45) or to any of the examples described herein, further comprising that the one or more simulation parameters comprise at least one simulation parameter related to a software setting controlling the behavior of the hardware device.

Another example (e.g., example 47) relates to a previously described example (e.g., one of the examples 41 to 46) or to any of the examples described herein, further comprising that the hardware device is a memory controller for interfacing with one or more memory modules via one or more memory module slots, wherein the one or more simulation parameters comprise at least one simulation parameter related to a population of the one or more memory module slots.

Another example (e.g., example 48) relates to a previously described example (e.g., one of the examples 41 to 47) or to any of the examples described herein, further comprising that the hardware device is simulated based on code specifying the functionality of the hardware device, the code being based on a hardware description language.

Another example (e.g., example 49) relates to a previously described example (e.g., one of the examples 41 to 47) or to any of the examples described herein, further comprising that the hardware device is simulated based on a register transfer layer representation or a netlist representation of the hardware device.

Another example (e.g., example 50) relates to a previously described example (e.g., one of the examples 41 to 47) or to any of the examples described herein, further comprising that the hardware device is simulated using a field-programmable gate array or using an existing hardware implementation of the hardware device.

Another example (e.g., example 51) relates to a previously described example (e.g., one of the examples 41 to 50) or to any of the examples described herein, further comprising that the hardware device is a memory controller for interfacing with one or more memory modules via one or more memory module slots.

Another example (e.g., example 52) relates to a previously described example (e.g., example 51) or to any of the examples described herein, further comprising that the one or more unit tests relate to an electronic signal training flow for initializing the one or more memory modules.

Another example (e.g., example 53) relates to a previously described example (e.g., one of the examples 51 to 52) or to any of the examples described herein, further comprising that the timeline of changes of the transaction data relates to a response of the one or more memory modules to an electronic training signal provided by the memory controller.

Another example (e.g., example 54) relates to a previously described example (e.g., example 53) or to any of the examples described herein, further comprising that the timeline of changes of the transaction data comprises a timeline of state or content changes of one or more registers of the simulated hardware device, with values of the one or more registers indicating a result of a training of the one or more memory modules.

Another example (e.g., example 55) relates to a previously described example (e.g., one of the examples 41 to 54) or to any of the examples described herein, further comprising that the simulation is performed using a plurality of sets of one or more simulation parameters.

Another example (e.g., example 56) relates to a previously described example (e.g., example 55) or to any of the examples described herein, further comprising that the hardware device is a memory controller for interfacing with one or more memory modules via one or more memory module slots, wherein the one or more unit tests relate to an electrical signal training flow for initializing the one or more memory modules, wherein the plurality of sets of one or more simulation parameters are based on a plurality of training patterns being used for performing the electrical signal training flow.

Another example (e.g., example 57) relates to a previously described example (e.g., example 56) or to any of the examples described herein, further comprising that the timeline of changes of the transaction data is obtained by simulating (210) the hardware device based on the one or more simulation parameters, storing (220) transaction data encountered at one or more interfaces of the hardware device during simulation of the hardware device, and determining (230) the timeline of changes of the transaction data based on the stored transaction data.

Another example (e.g., example 58) relates to a previously described example (e.g., example 57) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 59) relates to a method for preparing data suitable for performing unit tests on firmware code, the firmware code being suitable for interacting with a hardware device, the method comprising simulating (210) the hardware device based on one or more simulation parameters, the one or more simulation parameters being defined by one or more unit tests to be performed on the firmware code. The method comprises storing (220) transaction data encountered at one or more interfaces of the hardware device during simulation of the hardware device. The method comprises determining (230) a timeline of changes of the transaction data encountered at the one or more interfaces of the hardware device.

Another example (e.g., example 60) relates to a previously described example (e.g., example 59) or to any of the examples described herein, further comprising that the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

An example (e.g., example 61) relates to a system comprising the apparatus (10) according to one of the examples 1 to 18 and the apparatus (20) according to one of the examples 19 or 20.

An example (e.g., example 62) relates to a system comprising the device (10) according to one of the examples 21 to 38 and the device (20) according to one of the examples 39 or 30.

An example (e.g., example 63) relates to a machine-readable storage medium including program code, when executed, to cause a machine to perform the method of one of the examples 41 to 58 or the method according to one of the examples 59 or 60.

An example (e.g., example 64) relates to a computer program having a program code for performing the method of one of the examples 41 to 58 or the method according to one of the examples 59 or 60 when the computer program is executed on a computer, a processor, or a programmable hardware component.

An example (e.g., example 65) relates to a machine-readable storage including machine readable instructions, when executed, to implement a method or realize an apparatus as claimed in any pending claim or shown in any example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for performing unit tests on firmware code, the firmware code being suitable for interacting with a hardware device, the apparatus comprising interface circuitry and processing circuitry to:
obtain a timeline of changes of transaction data encountered at one or more interfaces of the hardware device during simulation of the hardware device, the simulation being based on one or more simulation parameters defined by one or more unit tests to be performed on the firmware code; and
perform the one or more unit tests of the firmware code using the timeline of changes of transaction data of the simulated hardware device, the one or more unit tests being based on the one or more simulation parameters.

2. The apparatus according to claim 1, wherein the firmware code interacts with the hardware device via one or more registers of the hardware device.

3. The apparatus according to claim 2, wherein the timeline of changes of the transaction data represent changes of a state or content of the one or more registers of the hardware device over time, wherein the one or more unit tests are performed using the changes of the state or content of the one or more registers of the hardware device over time.

4. The apparatus according to claim 1, wherein the timeline of changes of the transaction data encountered at the one or more interfaces of the hardware device is an abstract representation of a behavior of the hardware device to be encountered during the one or more unit tests.

5. The apparatus according to claim 1, wherein the one or more simulation parameters comprise at least one simulation parameter related to a setting of the hardware device.

6. The apparatus according to claim 1, wherein the one or more simulation parameters comprise at least one simulation parameter related to a software setting controlling the behavior of the hardware device.

7. The apparatus according to claim 1, wherein the hardware device is a memory controller for interfacing with one or more memory modules via one or more memory module slots, wherein the one or more simulation parameters comprise at least one simulation parameter related to a population of the one or more memory module slots.

8. The apparatus according to claim 1, wherein the hardware device is simulated based on code specifying the functionality of the hardware device, the code being based on a hardware description language.

9. The apparatus according to claim 1, wherein the hardware device is simulated based on a register transfer layer representation or a netlist representation of the hardware device.

10. The apparatus according to claim 1, wherein the hardware device is simulated using a field-programmable gate array or using an existing hardware implementation of the hardware device.

11. The apparatus according to claim 1, wherein the hardware device is a memory controller for interfacing with one or more memory modules via one or more memory module slots.

12. The apparatus according to claim 11, wherein the one or more unit tests relate to an electronic signal training flow for initializing the one or more memory modules.

13. The apparatus according to claim 11, wherein the timeline of changes of the transaction data relates to a response of the one or more memory modules to an electronic training signal provided by the memory controller.

14. The apparatus according to claim 13, wherein the timeline of changes of the transaction data comprises a timeline of state or content changes of one or more registers of the simulated hardware device, with values of the one or more registers indicating a result of a training of the one or more memory modules.

15-16. (canceled)

17. The apparatus according to claim 1, wherein the processing circuitry is to obtain the timeline of changes of the transaction data by simulating the hardware device based on the one or more simulation parameters, storing transaction data encountered at one or more interfaces of the hardware device during simulation of the hardware device, and determining the timeline of changes of the transaction data based on the stored transaction data.

18. The apparatus according to claim 17, wherein the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

19. An apparatus for preparing data suitable for performing unit tests on firmware code, the firmware code being suitable for interacting with a hardware device, the apparatus comprising interface circuitry and processing circuitry to:
simulate the hardware device based on one or more simulation parameters, the one or more simulation parameters being defined by one or more unit tests to be performed on the firmware code;
store transaction data encountered at one or more interfaces of the hardware device during simulation of the hardware device; and
determine a timeline of changes of the transaction data encountered at the one or more interfaces of the hardware device.

20. The apparatus according to claim 19, wherein the act of storing the transaction data comprises storing a state or content of one or more registers of the simulated hardware device encountered during simulation, wherein the act of determining the timeline of changes of the transaction data comprises determining a timeline of state or content changes of the one or more registers of the simulated hardware device, and wherein the one or more unit tests are performed using the timeline of state or content changes of the one or more registers of the simulated hardware device.

21-22. (canceled)

23. A method for performing unit tests on firmware code, the firmware code being suitable for interacting with a hardware device, the method comprising:
obtaining a timeline of changes of transaction data encountered at one or more interfaces of the hardware device during simulation of the hardware device, the simulation being based on one or more simulation parameters defined by one or more unit tests to be performed on the firmware code; and
performing the one or more unit tests of the firmware code using the timeline of changes of transaction data of the simulated hardware device, the one or more unit tests being based on the one or more simulation parameters.

24. (canceled)

25. A machine-readable storage medium including program code, when executed, to cause a machine to perform the method of claim 23.
